(19) United States
(12) Patent Application Publication
(10) Pub. No.: US 2025/0065824 A1
(43) Pub. Date: Feb. 27, 2025

(54) VEHICLE-MOUNTED RESTROOM SOUND PROCESSING SYSTEM, VEHICLE-MOUNTED RESTROOM, AND VEHICLE

(71) Applicant: Divine Vision (Shenzhen) Culture Technology Co., Ltd., Shenzhen (CN)

(72) Inventors: Wei ZENG, Beijing (CN); Jiangyue CHEN, Beijing (CN)

(21) Appl. No.: 18/802,031

(22) Filed: Aug. 13, 2024

(30) Foreign Application Priority Data
Aug. 22, 2023 (CN) 202311070334.1

(51) Int. Cl. B60R 15/04; G10K 11/172

(52) U.S. Cl. CPC B60R 15/04; G10K 11/172

(57) ABSTRACT

Embodiments of the application present a method and electronic device for providing product object information. The method includes: identifying at least one target product object and its original descriptive information to be provided to a target user; determining national or regional attribute information of the target user; processing the original descriptive information to adapt to local expression based on the target user's national or regional attribute information to generate target descriptive information; and providing the target descriptive information corresponding to the at least one target product object to a client device of the target user to provide the target descriptive information on a designated webpage. These embodiments enable the expression of product object information on the designated webpage to achieve a “customized experience for each individual,” enhancing user experience and potentially increasing click-through rates and conversion rates.

### CROSS-REFERENCE TO RELATED APPLICATIONS

This application claims priority to Chinese Patent Application No. 202311070334.1, filed with the China National Intellectual Property Administration on Aug. 22, 2023, and entitled “Vehicle-Mounted Restroom Sound Processing System, Vehicle-Mounted Restroom, and Vehicle,” which is incorporated herein by reference in its entirety.

### TECHNICAL FIELD

The present disclosure relates to the field of restrooms, and more particularly, to a sound processing system for a vehicle-mounted restroom, a vehicle-mounted restroom, and a vehicle.

### BACKGROUND

Due to the space constraints of vehicle-mounted restrooms, the distance between the occupants and the restroom cannot be expanded. Various privacy sounds generated during the use of the restroom cause disturbances to both the user and the occupants. Some smart toilets have emerged on the market, capable of playing music to neutralize privacy sounds during use. However, this solution uses traditional speakers to play music, and the speakers are integrated on the toilet, suitable for restrooms with separate dry and wet areas, whereas vehicle-mounted restrooms typically cannot achieve dry and wet separation. Additionally, if the volume of the played music is low, it cannot effectively cover privacy sounds; if the volume is too high, it causes discomfort to the restroom user. Furthermore, it cannot prevent eavesdropping on sounds inside the vehicle-mounted restroom through the installation of listening devices on exposed walls.

### SUMMARY

In view of this, the present disclosure provides a sound processing system for a vehicle-mounted restroom, a vehicle-mounted restroom, and a vehicle, which can effectively mask the privacy sounds within the vehicle-mounted restroom and prevent eavesdropping.

According to one aspect of the present disclosure, a sound processing system for a vehicle-mounted restroom is provided, including: a resonance sound-producing device, including one or more resonance drivers set within walls of the vehicle-mounted restroom, used to emit sound by driving the walls to resonate; a processing device, configured to: control at least one of the resonance drivers in the resonance sound-producing device to drive the wall to emit sound, thereby masking sounds within the vehicle-mounted restroom.

In one possible implementation, the system further includes: a door lock detection device and a human body detection device set within the vehicle-mounted restroom. The door lock detection device is used to detect the lock status of the vehicle-mounted restroom door, including a closed state or an open state; the human body detection device is used to detect the presence of a human body within the vehicle-mounted restroom. The controlling at least one of the resonance drivers in the resonance sound-producing device to drive the wall to emit sound, thereby masking the sounds within the vehicle-mounted restroom, includes: controlling at least one resonance driver to drive the wall to emit sound when the door lock detection device detects that the restroom door is closed, and the human body detection device detects the presence of a human body within the restroom.

In one possible implementation, the system further includes: a human position detection device and a volume detection device set outside the vehicle-mounted restroom. The human position detection device is used to detect the position of a human body outside the vehicle-mounted restroom relative to the restroom; the volume detection device is used to detect the outdoor ambient noise level outside the vehicle-mounted restroom. The controlling at least one of the resonance drivers in the resonance sound-producing device to drive the wall to emit sound, thereby masking the sounds within the vehicle-mounted restroom, includes: determining a target volume of the sound to be emitted and the resonance driver to be controlled based on the detected human position and the detected outdoor ambient noise level, and controlling at least one resonance driver to drive the wall to emit sound at the target volume, thereby masking the sounds within the vehicle-mounted restroom.

In one possible implementation, determining the target volume of the sound to be emitted and the resonance driver to be controlled based on the detected human position and the detected outdoor ambient noise level includes: determining at least one resonance driver corresponding to the detected human position; determining the target volume required by the at least one resonance driver corresponding to the detected human position based on the detected human position and the detected outdoor ambient noise level.

In one possible implementation, the human position indicates the distance between the human body outside the vehicle-mounted restroom and the restroom, wherein the distance is inversely related to the target volume, and the outdoor ambient noise level is inversely related to the target volume.

In one possible implementation, the processing device is further configured to: control the at least one resonance driver to stop driving the wall to resonate and stop emitting sound when the door lock detection device detects that the restroom door is open, or the human body detection device detects that there is no human body within the restroom.

In one possible implementation, at least one wall of the vehicle-mounted restroom is provided with one or more resonance drivers, arranged in an array if multiple resonance drivers are set within the wall.

According to another aspect of the present disclosure, a vehicle-mounted restroom is provided, including: restroom supporting equipment and the sound processing system for the vehicle-mounted restroom.

In one possible implementation, an inner wall surface of the vehicle-mounted restroom is provided with a resonance wall panel, wherein the resonance driver set within the wall is in contact with the resonance wall panel, and the resonance driver is used to drive the resonance wall panel to resonate and emit sound within the vehicle-mounted restroom.

In one possible implementation, at least one wall of the vehicle-mounted restroom is provided with soundproofing material, located between an outer surface of the wall and the resonance driver set within the wall.

According to another aspect of the present disclosure, a vehicle is provided, including the vehicle-mounted restroom.

According to the embodiments of the present disclosure, since the resonance sound-producing device is set within the walls of the vehicle-mounted restroom, it can be applied to vehicle-mounted restrooms without dry and wet separation. By controlling the resonance driver set within the wall of the vehicle-mounted restroom to drive the wall to resonate and emit sound, the wall becomes a medium for sound generation and propagation. This can block eavesdropping devices installed outside the wall from listening in, while the processing device can control at least one resonance driver to drive the wall to resonate, making it convenient to adjust the volume by controlling the resonance intensity, thereby effectively masking the sounds within the vehicle-mounted restroom from spreading outside.

The other features and aspects of the present disclosure will become apparent from the following detailed description of exemplary embodiments with reference to the accompanying drawings.

### BRIEF DESCRIPTION OF THE DRAWINGS

The accompanying drawings, which are included in the specification and constitute a part of it, illustrate exemplary embodiments, features, and aspects of the present disclosure and are used to explain the principles of the present disclosure.

FIG. 1 shows a schematic diagram of an entertainment and film production vehicle according to one embodiment of the present disclosure.

FIG. 2 shows a schematic diagram of a vehicle-mounted restroom according to one embodiment of the present disclosure.

FIG. 3 shows a block diagram of a sound processing system for a vehicle-mounted restroom according to one embodiment of the present disclosure.

FIG. 4 shows a schematic diagram of an array arrangement of multiple resonance drivers according to one embodiment of the present disclosure.

FIG. 5 shows a schematic diagram of a wall structure of a vehicle-mounted restroom according to one embodiment of the present disclosure.

FIG. 6 shows a schematic diagram of another wall structure of a vehicle-mounted restroom according to one embodiment of the present disclosure.

FIG. 7 shows a block diagram of the sound processing system for a vehicle-mounted restroom according to one embodiment of the present disclosure.

FIG. 8 shows a block diagram of the sound processing system for a vehicle-mounted restroom according to one embodiment of the present disclosure.

FIG. 9 shows a schematic diagram of a sound processing process in a vehicle-mounted restroom according to one embodiment of the present disclosure.

FIG. 10 shows a schematic diagram of an application scenario according to one embodiment of the present disclosure.

### DETAIL DESCRIPTION OF THE EMBODIMENTS

The following provides a detailed description of various exemplary embodiments, features, and aspects of the present disclosure with reference to the accompanying drawings. In the drawings, identical reference numerals indicate elements with the same or similar functions. Although various aspects of the embodiments are shown in the drawings, the drawings are not necessarily to scale unless specifically indicated.

The term “exemplary” as used herein means “serving as an example, instance, or illustration.” Any embodiment described as “exemplary” is not necessarily to be construed as superior or better than other embodiments.

Moreover, for better illustration of the present disclosure, numerous specific details are provided in the following detailed description. Those skilled in the art should understand that the present disclosure can be practiced without some of these specific details. In some instances, methods, means, elements, and circuits well known to those skilled in the art have not been described in detail to highlight the essence of the present disclosure.

The sound processing system for vehicle-mounted restrooms in the embodiments of this disclosure can be applied to various vehicles with onboard restrooms, such as entertainment and film production vehicles, film makeup vehicles, artist rest vehicles, RVs, and so on. As an example, the present disclosure provides an entertainment and film production vehicle as shown in FIG. 1. The entertainment and film production vehicle includes a driver's cabin, a work area, a rest area, and a vehicle-mounted restroom. As shown in FIG. 1, the entertainment and film production vehicle has a limited space within the vehicle. That means that various privacy sounds generated during the use of the restroom can disturb both the user and other occupants in the vehicle.

Therefore, the embodiments of this disclosure provide a sound processing system for vehicle-mounted restrooms. This system can be applied within the restroom without being affected by the non-separation of wet and dry areas. It effectively masks privacy sounds within the vehicle and simultaneously blocks eavesdropping attempts using external listening devices on the restroom walls.

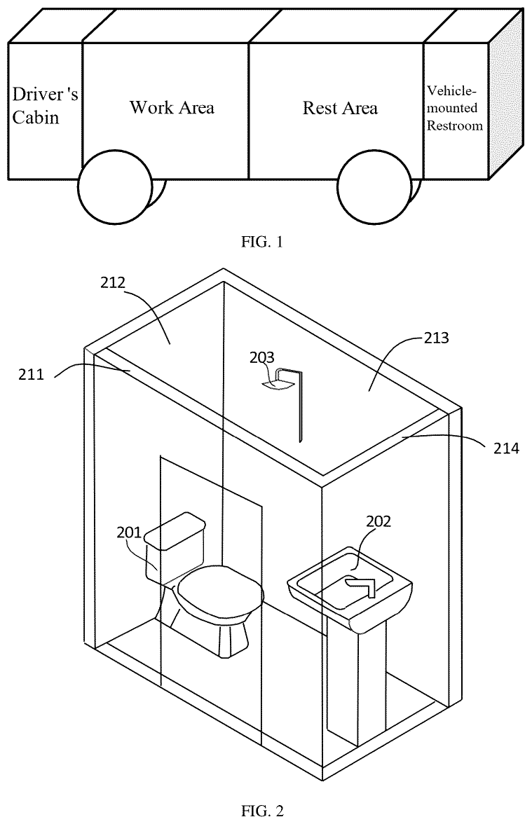

As an example, the embodiments of this disclosure provide a vehicle-mounted restroom as shown in FIG. 2. This vehicle-mounted restroom includes: a toilet 201, a wash basin 202, a shower 203, and other restroom-related equipment, and additionally, it includes the sound processing system as disclosed in the embodiments of this disclosure (not shown in FIG. 2). It should be understood that the vehicle-mounted restroom shown in FIG. 2 is an exemplary possible implementation provided by the embodiments of this disclosure. In practice, users can flexibly design the shape, structure, and types of restroom-related equipment inside the vehicle-mounted restroom according to personal preferences and/or actual application scenarios. This disclosure does not limit these aspects.

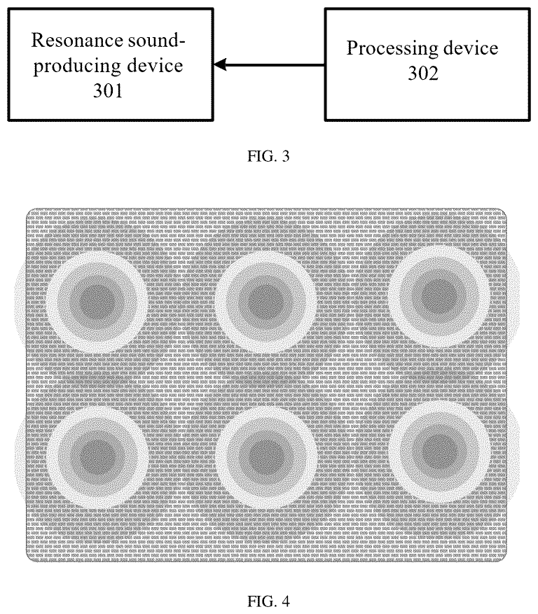

The following, with reference to FIGS. 3 to 10, provides detailed descriptions of the sound processing system for a vehicle-mounted restroom according to the embodiments of the present disclosure.

FIG. 3 illustrates a block diagram of the sound processing system for vehicle-mounted restrooms according to one embodiment of the present disclosure. This system can be applied to vehicle-mounted restrooms in various vehicles. As shown in FIG. 3, the system includes:
resonance sound-producing device 301, which includes one or more resonance drivers within the walls of the vehicle-mounted restroom, the resonance drivers being used to emit sound by driving the walls to resonate;
processing device 302, which is configured to control at least one resonance driver in the resonance sound-producing device 301 to drive the wall within which the at least one resonance driver is located to emit sound, thereby masking the sounds within the vehicle-mounted restroom.

It should be understood that a vehicle-mounted restroom is typically enclosed by multiple walls. Therefore, a hidden wall-embedded approach can be used to install resonance drivers within at least one of the walls. In other words, at least one wall of the vehicle-mounted restroom can, respectively, be equipped with one or more resonance drivers. For example, as shown in FIG. 2, the four walls 211, 212, 213, and 214 of the vehicle-mounted restroom can each have one or more resonance drivers installed. Alternatively, one or more resonance drivers can be installed within one wall. The embodiments of this disclosure do not limit the specific installation approach.

To maintain the integrity of the exterior surface of the walls, multiple resonance drivers can typically be embedded at various positions within multiple walls. This setup allows for more effective masking of privacy sounds within the vehicle-mounted restroom from multiple directions. When multiple resonance drivers are installed within a wall, they can be arranged in an array format. For instance, FIG. 4 illustrates one arrangement of multiple resonance drivers within a wall, where the resonance drivers are arranged in two rows and three columns.

In practical applications, the resonance drivers can use known resonance motors in the field, such as linear resonance motors. These types of resonance drivers can generate mechanical motion, thereby driving the walls to resonate synchronously and achieving sound conduction and propagation. The embodiments of this disclosure do not limit the types, models, etc., of the resonance drivers. Since the resonance drivers drive the walls to resonate and produce sound, the walls themselves become part of the sound source. As a result, it becomes impossible to use listening devices placed outside the walls to monitor the sounds within the walls. This effectively prevents sound information leakage from the vehicle-mounted restroom through wall conduction.

Optionally, to enhance the sound production by the resonance drivers embedded within the walls, the inner surface of the vehicle-mounted restroom walls can be equipped with resonance wall panels. These resonance wall panels can be made of materials that easily resonate, such as steel plates. The resonance drivers embedded within the walls of the vehicle-mounted restroom make contact with these resonance wall panels. The resonance drivers drive the resonance wall panels to resonate, thereby emitting sound in the vehicle-mounted restroom. This mechanism improves the propagation effect of the sound produced by the resonance drivers driving the wall resonance.

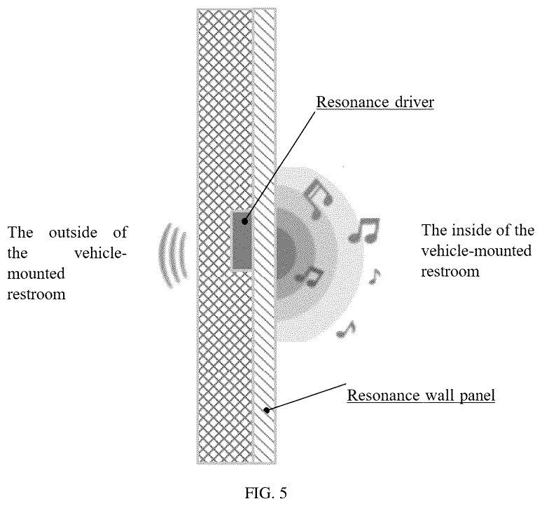

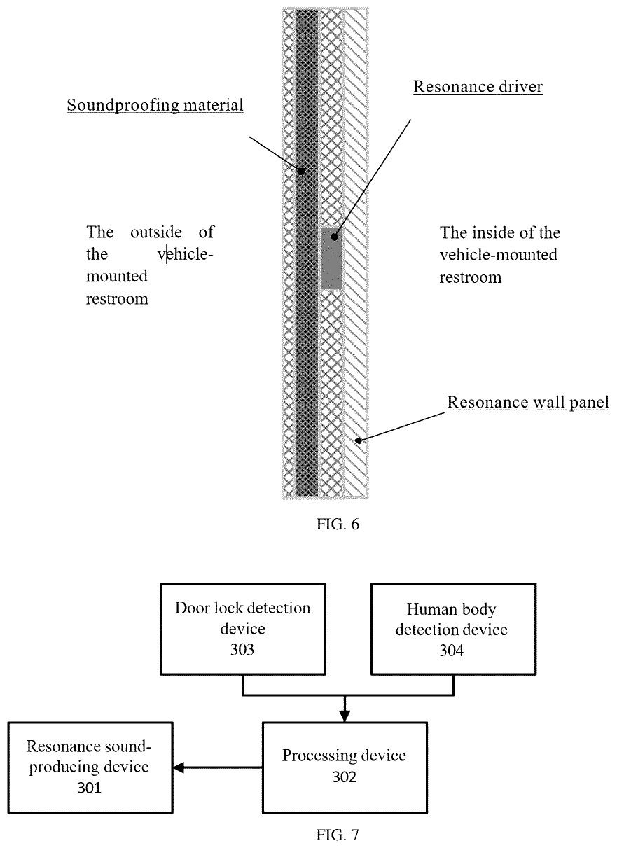

Exemplarily, FIG. 5 shows a schematic diagram of a wall structure of a vehicle-mounted restroom. As shown in FIG. 5, the resonance wall panel on the surface of the wall is set on the inside of the vehicle-mounted restroom, and the resonance driver is adjacent to the resonance wall panel. In practical applications, to more effectively block the propagation of sounds from within the vehicle-mounted restroom, soundproofing materials can also be installed within the walls of the restroom. As shown in FIG. 6, the soundproofing material can be placed between the outer surface of the wall and the resonance driver embedded within the wall. This arrangement helps to further prevent the transmission of sound outside the vehicle-mounted restroom.

It should be understood that the wall structures shown in FIGS. 5 and 6 are some possible implementations provided by the embodiments of this disclosure. In practice, those skilled in the art can design the wall structure of the vehicle-mounted restroom according to actual needs. The embodiments of this disclosure do not limit these design choices.

Each resonance driver in the resonance sound-producing device 301 is communicatively connected to the processing device 302. This connection can be established through cables for wired communication, allowing the processing device 302 to control at least one resonance driver in the resonance sound-producing device 301 to drive the corresponding wall to emit sound. The sound emitted by the resonance drivers driving the wall to resonate can be soft pink noise, white noise, or music with melody or rhythm, providing a relaxed and secure atmosphere for the users of the vehicle-mounted restroom. The embodiments of this disclosure do not limit the types of sounds emitted by the wall resonance. It should be understood that by controlling the vibration frequency and vibration intensity of the resonance drivers, different types and volumes of sound can be emitted from the walls.

It should be understood that technicians can flexibly set the spatial position of the processing device 302 based on actual scenarios. For example, the processing device 302 can be placed inside or outside the vehicle-mounted restroom. The processing device 302 can be an independent device, such as a Central Processing Unit (CPU), an Application Specific Integrated Circuit (ASIC), a Field Programmable Gate Array (FPGA), a general-purpose processor, a controller, a microcontroller, etc. Alternatively, the processing device 302 can be a processing unit integrated into the vehicle's central control system. The embodiments of this disclosure do not limit the type or position of the processing device 302.

Optionally, a switch device can be installed inside the vehicle-mounted restroom to control the activation and deactivation of the sound processing system. When a user enters the restroom and wishes to mask the sounds generated during use, she/he can activate the sound processing system using this switch device. Conversely, when sound masking is not needed, the user can deactivate the sound processing system using the switch device.

Optionally, to control the system more intelligently, one possible implementation includes additional components as shown in FIG. 7: a door lock detection device 303 and a human body detection device 304. The door lock detection device 303 is used to detect the lock status of the vehicle-mounted restroom door, including whether the door is in a closed state or an open state. The human body detection device 304 is used to detect whether there is a human presence inside the vehicle-mounted restroom.

Based on the system shown in FIG. 7, the processing device 302 controls at least one resonance driver in the resonance sound-producing device 301 to drive the corresponding wall to emit sound, thereby masking the sounds within the vehicle-mounted restroom. This process includes:
when the door lock detection device 303 detects that the vehicle-mounted restroom door is in a closed state, and the human body detection device 304 detects the presence of a human inside the restroom, the processing device 302 controls at least one resonance driver in the resonance sound-producing device 301 to drive the corresponding wall to emit sound, thereby masking the sounds within the vehicle-mounted restroom.

The door lock detection device 303 and the human body detection device 304 can each be communicatively connected to the processing device 302, thus allowing the door lock detection device 303 to send the detected lock status to the processing device 302, and the human body detection device 304 to send the detected results of whether there is a human presence inside the vehicle-mounted restroom to the processing device 302.

In practical applications, the door lock detection device 303 can be installed at the door lock of the vehicle-mounted restroom to conveniently detect the lock status. It should be understood that those skilled in the art can use known sensor technologies to implement the door lock detection device 303, as long as it achieves the required functionality. The embodiments of this disclosure do not limit the type, structure, etc., of the door lock detection device 303.

In practical applications, the spatial position of the human body detection device 304 within the vehicle-mounted restroom can be set according to actual needs, as long as the detection range of the human body detection device can cover the entire restroom. For example, it can be installed on the ceiling of the vehicle-mounted restroom to fully detect whether there is a human presence inside. It should be understood that those skilled in the art can use known sensor technologies to implement the human body detection device 304, as long as it achieves the required functionality. The embodiments of this disclosure do not limit the type, structure, etc., of the human body detection device.

Considering that the door lock of the vehicle-mounted restroom being in a closed state does not necessarily mean that there are people inside—it could have been locked from the outside—and merely having people inside the restroom does not necessarily mean that sound masking is needed, as the door lock might be in an open state, the embodiments of this disclosure determine that the resonance sound-producing device 301 should be activated to achieve sound masking when there is a human presence inside the restroom and the door lock is in a closed state. Therefore, the embodiments of this disclosure use the door lock detection device 303 to detect the lock status in combination with the human body detection device 304 to detect whether there is a human presence inside the restroom. This comprehensive determination ensures whether to activate the resonance sound-producing device 301 to mask sounds within the vehicle-mounted restroom. This approach enables a more precise and intelligent sound masking function, while also preventing unnecessary energy waste.

Thus, the processing device 302 can control at least one resonance driver in the resonance sound-producing device 301 to drive the corresponding wall to emit sound, thereby masking the sounds within the vehicle-mounted restroom, in the situation that the door lock detection device 303 detects the door lock is in a closed state (i.e., the lock status sent by the door lock detection device 303 is closed) and the human body detection device 304 detects the presence of a human inside the restroom (i.e., the detection result sent by the human body detection device 304 indicates a human presence in the vehicle-mounted restroom). The processing device 302 can also perform the following actions: when the door lock detection device 303 detects that the door lock of the vehicle-mounted restroom is in an open state, or the human body detection device 304 detects that there is no human presence inside the restroom, it controls at least one resonance driver to stop driving the wall resonance, thereby stopping the sound emission. This method allows the system to more intelligently manage the activation and deactivation of the sound masking function.

Considering that the actual environment around the vehicle-mounted restroom is constantly changing, meaning that the outdoor ambient noise level outside the restroom varies and the distance between external personnel and the restroom also changes, adjustments can be made accordingly. If the outdoor ambient noise level is high (i.e., the environment is noisy), the sounds within the restroom will not be easily heard by people outside. Conversely, if the outdoor ambient noise level is low (i.e., the environment is quiet), the sounds within the restroom will be more easily heard by people outside. Similarly, if external personnel are close to the restroom, they will be more likely to hear the sounds from within. Conversely, if they are farther away, they will be less likely to hear the sounds. Therefore, the system can dynamically adjust the volume of the emitted sound based on the outdoor ambient noise level and the position of external personnel to achieve optimal sound masking in different environments.

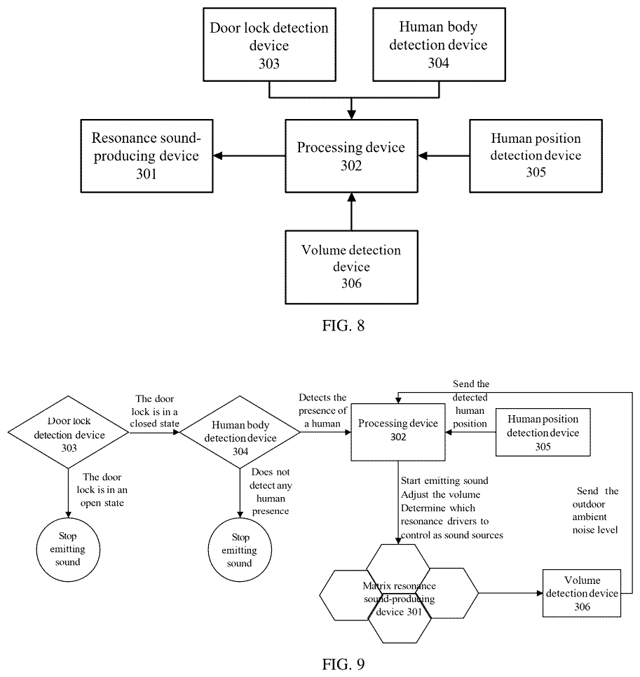

Based on this, in one possible implementation, as shown in FIG. 8, the system also includes: a human position detection device 305 and a volume detection device 306 installed outside the vehicle-mounted restroom. The human position detection device 305 is used to detect the position of a human outside of the restroom relative to the restroom; the volume detection device 306 is used to detect the outdoor ambient noise level outside the vehicle-mounted restroom.

Based on the system shown in FIG. 8, the processing device 302 controls at least one resonance driver in the resonance sound-producing device 301 to drive the corresponding wall to emit sound, thereby masking the sounds within the vehicle-mounted restroom. This process includes:
when the human position detection device 305 detects the position of a human, the processing device 302 determines the target volume of the sound to be emitted and the specific resonance driver(s) to be controlled based on the position detected by the human position detection device 305 and the outdoor ambient noise level detected by the volume detection device 306; the processing device 302 then controls the specific resonance driver(s) to drive the corresponding wall to emit sound at the target volume, thereby masking the sounds within the vehicle-mounted restroom.

Since the position of the human body outside can vary, there may be situations where the human position detection device does not detect a human presence. In this case, it can be assumed that no one is near the vehicle-mounted restroom. The human position can be set to a large value (indicating a far distance from the restroom), and the target volume can be determined based on this set human position and the detected outdoor ambient noise level. Alternatively, in this situation, the target volume can be determined based solely on the outdoor ambient noise level.

The human position detection device 305 and the volume detection device 306 can each be communicatively connected to the processing device 302. This setup allows the human position detection device 305 to send the detected human position to the processing device 302, and the volume detection device 306 to send the detected outdoor ambient noise level to the processing device 302. With this arrangement, the processing device 302, in conjunction with the human position detection device 305 and the volume detection device 306, can dynamically adjust the volume of the sound emitted by the system based on the proximity of external personnel and the outdoor ambient noise level. This enables the system to increase or decrease the sound volume appropriately when people are approaching or moving away.

In practical applications, technicians can set the specific spatial positions of the human position detection device 305 and the volume detection device 306 outside the vehicle-mounted restroom according to actual needs, as long as they can detect the position of people outside the restroom and the outdoor ambient noise level. The system may include one or more human position detection devices 305, which can be distributed around the vehicle-mounted restroom to detect the positions of people in various directions around the restroom. Alternatively, a single human position detection device can be installed within the vehicle housing the restroom to primarily detect the positions of people inside the vehicle but outside the restroom. Similarly, the system may include one or more volume detection devices 306, which can be distributed around the vehicle-mounted restroom to detect the outdoor ambient noise levels in different directions around the restroom. Alternatively, a single volume detection device can be installed within the vehicle housing the restroom to primarily detect the outdoor ambient noise level inside the vehicle but outside the restroom.

Technicians in the field can use known sensor technology and artificial intelligence technology to implement the human position detection device 305. This device can not only detect whether there is a human presence in the space but also determine the position of the human body when a presence is detected. The embodiments of this disclosure do not limit the type, structure, or function of the human position detection device 305, as long as it can achieve the required functionality.

Exemplarily, a spatial coordinate system can be established with the center of the vehicle-mounted restroom as the origin. The human position detected by the human position detection device 305 can be represented as coordinates in this spatial coordinate system. Therefore, the human position can be used to indicate the distance between a person outside the vehicle-mounted restroom and the restroom itself. For example, the coordinate values of the human position can directly determine this distance, or the distance between the human position and the center of the vehicle-mounted restroom can be calculated using the distance formula between two points. The embodiments of this disclosure do not limit this approach. The distance between the person outside the vehicle-mounted restroom and the restroom is inversely related to the target volume, and the outdoor ambient noise level is also inversely related to the target volume. Consequently, when the outdoor ambient noise level is low and the indicated distance is short, the target volume can be larger; when the outdoor ambient noise level is high and the indicated distance is long, the target volume can be smaller, potentially even deactivating the resonance driver. In other situations (e.g., low ambient noise level and long indicated distance, or high ambient noise level and short indicated distance), a moderate default volume can be used as the target volume.

Technicians in the field can use known volume detection technologies, such as decibel meters, to implement the volume detection device 306. As long as the device achieves the required functionality, the embodiments of this disclosure do not limit the type, structure, or other aspects of the volume detection device 306.

In practical applications, a mapping relationship between the human position, outdoor ambient noise level, and the required system volume can be established in advance. This way, when the processing device 302 obtains the current human position detected by the human position detection device 305 and the current outdoor ambient noise level detected by the volume detection device 306, it can input these values into the pre-established mapping relationship to determine the target volume of the sound that should be emitted. By using this method, the system can more accurately determine the target volume needed to effectively mask the sounds within the vehicle-mounted restroom based on the outdoor ambient noise level and the human position.

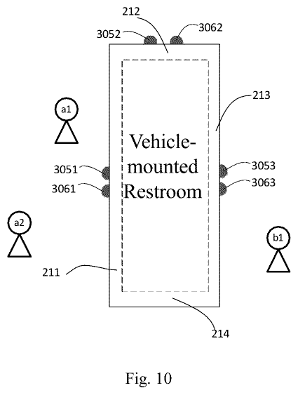

Based on the system shown in FIG. 8, the embodiments of this disclosure provide a schematic diagram of a sound processing flow within a vehicle-mounted restroom, as shown in FIG. 9. As illustrated in FIG. 9, when the door lock detection device 303 detects that the door lock is in a closed state and the human body detection device 304 detects the presence of a human, the processing device 302 can control the matrix resonance sound-producing device 301 (which includes multiple resonance drivers arranged in an array) to start emitting sound by driving the walls to resonate. If the door lock detection device 303 detects that the door lock is in an open state or the human body detection device 304 does not detect any human presence, the processing device 302 can control the resonance sound-producing device 301 to stop emitting sound. The human position detection device 305 and the volume detection device 306, installed outside the vehicle-mounted restroom, send the detected human position and outdoor ambient noise level to the processing device 302. The processing device 302 dynamically adjusts the volume (i.e., determines the target volume of the sound emitted by the resonance sound-producing device 301) based on the detected human position and outdoor ambient noise level. Additionally, the processing device 302 can dynamically determine which resonance drivers to control as sound sources. Resonance drivers at different positions serve as sound sources that drive wall resonance, affecting the direction of sound masking differently. For example, resonance drivers in the north wall can primarily mask the propagation of restroom sounds towards the north direction. As a result, people outside the north wall would hear sounds interfered with by the resonance emitted from that wall. Although sounds from other walls also contribute to the interference, the interference from the north wall is more significant, thus providing effective masking. A relationship can be established between specific regions around the restroom and the corresponding walls. When a human position falls within a particular region, the corresponding wall can be identified. The processing device 302 can then control all or some of the resonance drivers within that wall to drive resonance. The selected some resonance drivers could be the ones closest to the detected human position.

In the processing device 302, a sound playback module and a sound feedback adjustment module can be deployed. The sound feedback adjustment module dynamically determines the required resonance drivers in the resonance sound-producing device 301 and the target volume of the sound to be emitted based on the detected human position and the detected outdoor ambient noise level. The sound playback module then uses the required resonance drivers and target volume determined by the sound feedback adjustment module to control the required resonance driver in the resonance sound-producing device 301, driving the wall to emit sound at the target volume.

As described above, one or more resonance drivers can be installed in multiple walls of the vehicle-mounted restroom. Resonance drivers at different positions act as sound sources that drive wall resonance, each affecting the direction of sound masking differently. By combining the detected human position with the specific resonance drivers, zoned control can be achieved. This allows for more effective masking of restroom sounds in the direction of the detected human position without disturbing the user inside the restroom.

Thus, in one possible implementation, determining the target volume of the sound to be emitted and the specific resonance drivers to be controlled based on the detected human position by the human position detection device 305 and the detected outdoor ambient noise level by the volume detection device 306 includes:
determining at least one resonance driver corresponding to the detected human position based on the detected human position;
determining the target volume that the determined at least one resonance driver needed to produce based on the detected human position and the detected outdoor ambient noise level.

The at least one resonance driver corresponding to the detected human position can be understood as the resonance driver(s) capable of masking the propagation of sounds from the vehicle-mounted restroom to the detected human position. In practical applications, the current resonance drivers to be controlled (i.e., those corresponding to the detected human position) can be determined by evaluating the distance between the walls and the human position or the distance between the resonance drivers within the walls and the human position. For example, the resonance driver(s) to be controlled can be the resonance driver(s) in the wall that is closest to the human position, or the resonance driver(s) whose distance from the human position is less than a specified threshold.

It should be understood that multiple individuals may appear outside the vehicle-mounted restroom, and therefore a single human position detection device 305 might detect multiple human positions. In this case, the human position detection device 305 can send the detected human positions that are closest to the detection device 305 or the wall to the processing device 302. Or it can send all detected human positions to the processing device 302. The processing device 302 can then determine the resonance drivers to be controlled and the target volume based on the closest human positions. As described above, the system can also include multiple human position detection devices 305. These devices can detect human positions from different directions around the vehicle-mounted restroom. In this case, based on the human positions detected by each human position detection device 305, the corresponding resonance drivers and target volume can be determined. Then, the processing device 302 can control the corresponding resonance drivers to drive the walls to emit sounds at the respective target volumes, effectively masking the restroom sounds based on the detected human positions.

Exemplarily, an application scenario is illustrated in FIG. 10. As shown in FIG. 10, human position detection devices (3051, 3052, 3053) and volume detection devices (3061, 3062, 3063) are respectively installed outside the walls 211, 212, and 213 of the vehicle-mounted restroom in a top-down view. It should be understood that outdoor ambient noise is usually constantly present, so the three volume detection devices can send the real-time collected outdoor ambient noise levels to the processing device 302. For the situation where there are two individuals, a1 and a2, outside wall 211, since individual a1 is closer to the vehicle-mounted restroom (e.g., closer to wall 211) than individual a2, the human position detection device 3051 can send the detected position of individual a1 to the processing device 302. The processing device 302 can then determine at least one corresponding resonance driver based on the position of individual a1 and the outdoor ambient noise level detected by the volume detection device 3061 (for example, all resonance drivers installed within wall 211, or some specific resonance drivers within wall 211 that are at a distance less than a specified threshold from the position of individual a1, wall 211 being the wall corresponding to the location of individual a1). The processing device 302 can also determine the target volume L1 for the corresponding resonance driver(s) corresponding to the position of individual a1 (for example, based on the distance between individual a1 and wall 211 and/or the outdoor ambient noise level). The processing device 302 then controls the resonance driver(s) corresponding to the position of individual a1 to drive the wall to emit sound at the target volume L1.

For the situation where individual b1 is outside wall 213, the human position detection device 3053 can directly send the detected position of individual b1 to the processing device 302. The processing device 302 can then determine at least one corresponding resonance driver based on the position of individual b1 and the outdoor ambient noise level detected by the volume detection device 3063 (for example, all resonance drivers installed within wall 213, or some specific resonance drivers within wall 213 that are at a distance less than a specified threshold from the position of individual b1). The processing device 302 also determines the target volume L2 for the corresponding resonance driver(s) based on the position of individual b1 and/or the outdoor ambient noise level. The processing device 302 then controls the resonance driver(s) corresponding to the position of individual b1 to drive the wall to emit sound at the target volume L2.

In the situation where there are no individuals outside wall 212, i.e., the human position detection device 3052 does not detect any human positions, the processing device 302 can use a preset human position (a large value representing no nearby individuals) and the outdoor ambient noise level sent by the volume detection device 3062 to determine the target volume L3 that the resonance drivers within wall 212 should produce. Alternatively, the target volume L3 can be determined solely based on the outdoor ambient noise level L3 sent by the volume detection device 3062. The processing device 302 then directly controls the resonance drivers within wall 212 to drive the wall to emit sound at the target volume L3.

As shown in FIG. 10, the wall 212 may not have human position detection devices or volume detection devices installed outside it. In this case, the wall 212 may either have no resonance drivers installed or have resonance drivers that operate at a default volume to drive the wall resonance. Alternatively, the resonance drivers within wall 212 can be controlled based on the target volume determined by the human position detection devices and volume detection devices installed outside walls 211 or 213. The target volume is based on the detected human positions and the outdoor ambient noise levels. The embodiments of this disclosure do not limit this arrangement.

It should be noted that the explanation using FIG. 10 as an example is just one exemplary embodiment provided by this disclosure and does not represent all possible embodiments. In practice, the shape of vehicle-mounted restrooms can vary greatly. Therefore, users can design the layout and quantity of human position detection devices and volume detection devices outside the restroom based on their actual needs. However, it should be understood by those skilled in the art that as long as the target volume to be emitted and the resonance drivers to be controlled are determined using the human positions detected by the human position detection devices and the outdoor ambient noise levels detected by the volume detection devices, such implementations fall within the protection scope of this disclosure.

According to the embodiments of this disclosure, using resonance drivers as sound-producing devices embedded within the walls and hidden from view makes the system suitable for vehicle-mounted restrooms without dry and wet separation. By utilizing wall resonance to produce sound, the walls become the primary medium for sound production and transmission, effectively blocking eavesdropping attempts via devices installed on the outer walls. The use of a matrix of multiple embedded resonance drivers allows for zoned control based on detected human positions, effectively disrupting the propagation of sounds within the vehicle-mounted restroom without disturbing the restroom user. Human position detection devices, ambient noise detection devices, door lock detection devices, and human presence detection devices enable the system to intelligently analyze the restroom's usage status. This allows for the automatic activation and deactivation of the resonance sound-producing device, adjustment of the sound source location based on human location, and intelligent volume adjustment. This approach ensures privacy protection and prevents eavesdropping.

As described above, the embodiments of this disclosure also provide a vehicle-mounted restroom, which includes restroom supporting equipment and the aforementioned sound processing system for the vehicle-mounted restroom.

In one possible implementation, the inner wall surface of the vehicle-mounted restroom is equipped with resonance wall panels. The resonance drivers installed within the walls of the vehicle-mounted restroom are in contact with these resonance wall panels. The resonance drivers are used to drive the resonance wall panels to vibrate, thereby emitting sound within the vehicle-mounted restroom.

In one possible implementation, at least one wall of the vehicle-mounted restroom is equipped with soundproofing material. This soundproofing material is located between the outer surface of the wall and the resonance drivers installed within the wall.

The embodiments of this disclosure also provide a vehicle that includes the aforementioned vehicle-mounted restroom. The vehicle can be an entertainment and film production vehicle, a film makeup vehicle, an artist rest vehicle, an RV, or other similar types of vehicles.

The flowcharts and block diagrams in the figures illustrate possible system architectures, functionalities, and operations according to various embodiments of this disclosure. In this context, each block in the flowchart or block diagram can represent a module that includes one or more executable instructions for performing the specified logical function. In some alternative implementations, the functions noted in the blocks can occur in a different order than what is illustrated in the figures. For example, two blocks shown in succession may be executed substantially in parallel or sometimes in the reverse order, depending on the functionality involved. It should also be noted that each block in the block diagrams and/or flowcharts, as well as combinations of blocks in the block diagrams and/or flowcharts, can be implemented using a dedicated hardware-based system that performs the specified functions or actions, or a combination of dedicated hardware and computer instructions.

The various embodiments of the present disclosure have been described above. These descriptions are exemplary and not exhaustive, and they are not limited to the disclosed embodiments. Many modifications and changes will be apparent to those skilled in the art without departing from the scope and spirit of the described embodiments. The terminology used herein is chosen to best explain the principles and practical applications of the embodiments or the technical improvements to the market, or to enable others skilled in the art to understand the embodiments disclosed herein.

What is claimed is:

1. A sound processing system for a vehicle-mounted restroom, comprising:
a resonance sound-producing device, including one or more resonance drivers embedded within walls of the vehicle-mounted restroom, the one or more resonance drivers being configured to emit sound by driving the walls to resonate; and
a processing device configured to perform controlling at least one of the one or more resonance drivers in the resonance sound-producing device to drive at least one corresponding wall to emit sound, thereby masking sounds within the vehicle-mounted restroom.

2. The system according to claim 1, further comprising:
a door lock detection device configured to detect a lock status of a vehicle-mounted restroom door, wherein the lock status includes a closed state and an open state; and
a human body detection device within the vehicle-mounted restroom and configured to detect the presence of a human body inside the vehicle-mounted restroom;
wherein the controlling at least one of the one or more resonance drivers in the resonance sound-producing device to drive at least one corresponding wall to emit sound, thereby masking the sounds within the vehicle-mounted restroom, comprises:
controlling at least one of the one or more resonance drivers in the resonance sound-producing device to drive the at least one corresponding wall to emit sound, thereby masking the sounds within the vehicle-mounted restroom when the door lock detection device detects that the lock status is in the closed state and the human body detection device detects the presence of a human body inside the vehicle-mounted restroom.

3. The system according to claim 1, further comprising:
a human position detection device and a volume detection device both installed outside the vehicle-mounted restroom, the human position detection device being configured to detect a position of a human body outside the vehicle-mounted restroom relative to the vehicle-mounted restroom, and the volume detection device being configured to detect an outdoor ambient noise level outside the vehicle-mounted restroom;
wherein the controlling of at least one of the one or more resonance drivers in the resonance sound-producing device to drive at least one corresponding wall to emit sound, thereby masking the sounds within the vehicle-mounted restroom, comprises:
determining a target volume of the sound to be emitted and at least one resonance driver to be controlled based on a human position detected by the human position detection device and an outdoor ambient noise level detected by the volume detection device; and
controlling the determined at least one resonance driver to drive at least one corresponding wall to emit sound at the target volume, thereby masking the sounds within the vehicle-mounted restroom.

4. The system according to claim 3, wherein the determining a target volume of the sound to be emitted and at least one resonance driver to be controlled based on a human position detected by the human position detection device and an outdoor ambient noise level detected by the volume detection device, comprises:
determining at least one resonance driver corresponding to the detected human position based on the detected human position; and
determining the target volume required to be produced by the determined at least one resonance driver corresponding to the detected human position based on the detected human position and the detected outdoor ambient noise level.

5. The system according to claim 4, wherein the human position is used to indicate a distance between the human body outside the vehicle-mounted restroom and the vehicle-mounted restroom, wherein the distance is inversely related to the target volume.

6. The system according to claim 4, wherein the outdoor ambient noise level is inversely related to the target volume.

7. The system according to claim 2, wherein the processing device is further configured to perform:
controlling the at least one of the one or more resonance drivers to stop driving the at least one corresponding wall and stop emitting sound when the door lock detection device detects that the lock status of the vehicle-mounted restroom is in an open state, or when the human body detection device detects the absence of a human body inside the vehicle-mounted restroom.

8. The system according to claim 1, wherein at least one wall of the vehicle-mounted restroom is provided with one or more resonance drivers, and in the case where multiple resonance drivers are installed within a wall, the multiple resonance drivers are arranged in an array.

9. A vehicle-mounted restroom, comprising:
a resonance sound-producing device, including resonance drivers embedded within walls of the vehicle-mounted restroom, wherein each of the walls has a resonance wall panel at an inner surface of the wall and the resonance driver installed within the wall is in contact with the resonance wall panel and is configured to drive the resonance wall panel to resonate to emit sound in the vehicle-mounted restroom;
a processing device configured to control one or more of the resonance drivers to drive the walls corresponding to the one or more resonance drivers to emit sound.

10. The vehicle-mounted restroom according to claim 9, wherein at least one wall of the vehicle-mounted restroom is provided with soundproofing material, the soundproofing material being located between an outer surface of the wall and the resonance driver within the wall.

11. The vehicle-mounted restroom according to claim 9, further comprising:
a door lock detection device configured to detect a lock status of a vehicle-mounted restroom door, wherein the lock status includes a closed state and an open state; and
a human body detection device within the vehicle-mounted restroom and configured to detect the presence of a human body inside the vehicle-mounted restroom,
wherein the processing device is further configured to control one or more of the resonance drivers to drive the walls corresponding to the one or more resonance drivers to emit sound when the door lock detection device detects that the lock status is in the closed state and the human body detection device detects the presence of a human body inside the vehicle-mounted restroom.

12. The vehicle-mounted restroom according to claim 11, wherein the processing device is further configured to control the one or more resonance drivers to stop driving the walls corresponding to the one or more resonance drivers when the door lock detection device detects that the lock status is an open state, or when the human body detection device detects the absence of a human body inside the vehicle-mounted restroom.

13. The vehicle-mounted restroom according to claim 9, further comprising:
a human position detection device and a volume detection device both installed outside the vehicle-mounted restroom, the human position detection device being configured to detect a position of a human body outside the vehicle-mounted restroom relative to the vehicle-mounted restroom, and the volume detection device being configured to detect an outdoor ambient noise level outside the vehicle-mounted restroom,
wherein the processing device is further configured to determine a target volume of the sound to be emitted and at least one resonance driver to be controlled based on a human position detected by the human position detection device and an outdoor ambient noise level detected by the volume detection device and control the determined at least one resonance driver to drive at least one corresponding wall to emit sound at the target volume.

14. The vehicle-mounted restroom according to claim 13, wherein, to determine a target volume of the sound to be emitted and at least one resonance driver to be controlled based on a human position detected by the human position detection device and an outdoor ambient noise level detected by the volume detection device, the processing device is further configured to:
determine at least one resonance driver corresponding to the detected human position based on the detected human position; and
determine the target volume required to be produced by the determined at least one resonance driver corresponding to the detected human position based on the detected human position and the detected outdoor ambient noise level.

15. The vehicle-mounted restroom according to claim 14, wherein the human position is used to indicate a distance between the human body outside the vehicle-mounted restroom and the vehicle-mounted restroom.

16. The vehicle-mounted restroom according to claim 15, wherein the distance is inversely related to the target volume.

17. The vehicle-mounted restroom according to claim 14, wherein the outdoor ambient noise level is inversely related to the target volume.

18. The vehicle-mounted restroom according to claim 9, wherein at least one wall includes multiple resonance drivers arranged in an array.

19. A vehicle, comprising:
a vehicle-mounted restroom comprising:
a resonance sound-producing device, including one or more resonance drivers embedded within walls of the vehicle-mounted restroom, the one or more resonance drivers being configured to emit sound by driving the walls to resonate; and
a processing device configured to perform controlling at least one of the one or more resonance drivers in the resonance sound-producing device to drive at least one corresponding wall to emit sound, thereby masking sounds within the vehicle-mounted restroom.

20. The vehicle according to claim 19, wherein each of the walls has a resonance wall panel at an inner surface of the wall and the resonance driver installed within the wall is in contact with the resonance wall panel and is configured to drive the resonance wall panel to resonate to emit sound in the vehicle-mounted restroom.
